(19) United States
(12) Patent Application Publication
(10) Pub. No.: US 2025/0206910 A1
(43) Pub. Date: Jun. 26, 2025

(54) RECYCLING METHOD OF POLYESTER COTTON BLENDED FABRIC

(71) Applicant: NAN YA PLASTICS CORPORATION, Taipei City (TW)

(72) Inventors: Te-Chao Liao, Taipei City (TW); Chung Yu Chen, Taipei City (TW); Chung-Chi Su, Taipei City (TW)

(73) Assignee: NAN YA PLASTICS CORPORATION, Taipei City (TW)

(21) Appl. No.: 18/631,056

(22) Filed: Apr. 10, 2024

(30) Foreign Application Priority Data
Dec. 26, 2023 (TW) 112150680

(51) Int. Cl. C08J 11/26; B09B 3/35; B09B 3/70; B09B 101/75; B09B 101/85; C08J 11/16

(52) U.S. Cl. CPC C08J 11/26; B09B 3/35; B09B 3/70; C08J 11/16; B09B 2101/75; B09B 2101/85; C08J 2301/02; C08J 2367/00

(57) ABSTRACT

The invention provides a recycling method of polyester cotton blended fabrics, which includes the following steps. First, the polyester cotton blend fabric is cuts into fragments. Afterwards, the fragments are placed in a reactor, a mixed aqueous solution of an acidic compound and a metal catalyst is added, a temperature is raised to 110° C. to 160° C., and a reaction is carried out for 1 to 6 hours to cleave the cotton fibers. Next, filter and separate to obtain cotton powders and a polyester fiber.

### CROSS-REFERENCE TO RELATED APPLICATION

This application claims the priority benefit of Taiwan application serial no. 112150680, filed on Dec. 26, 2023. The entirety of the above-mentioned patent application is hereby incorporated by reference herein and made a part of this specification.

### BACKGROUND

### Technical Field

The invention relates to a recycling method of fabrics, and in particular, to a recycling method of polyester cotton blended fabrics.

### Description of Related Art

With the improvement of people's living and consumption levels, the use cycle of textiles has been greatly shortened, resulting in a large amount of textile waste, of which polyester-cotton blended fabrics account for a high proportion. Therefore, how to recycle and reuse such waste textiles has become an important issue. In the conventional technology, the separation methods of polyester fiber and cotton blended fabrics mostly require the use of harmful substances (such as hydrochloric acid or concentrated phosphoric acid) or expensive solvents (such as NMMO) as catalysts or solvents, and the reaction must be carried out at high temperatures. It has the disadvantage of greater environmental burden or higher production cost.

Based on the above, developing a recycling method of polyester cotton blended fabrics to reduce production costs and avoid burdening the environment is an important topic currently required for research.

### SUMMARY

The invention provides a recycling method of polyester cotton blended fabrics, which can effectively reduce production costs and avoid burdening the environment.

The invention provides a recycling method of polyester cotton blended fabrics, which includes the following steps. First, the polyester cotton blend fabric is cuts into fragments. Afterwards, the fragments are placed in a reactor, a mixed aqueous solution of an acidic compound and a metal catalyst is added, a temperature is raised to 110° C. to 160° C., and a reaction is carried out for 1 to 6 hours to cleave the cotton fibers. Next, filter and separate to obtain cotton powders and a polyester fiber.

In an embodiment of the invention, a pressure within the reactor ranges from 1.5 bars to 12 bars.

In an embodiment of the invention, the acidic compound is an organic acid or an inorganic acid, the organic acid includes formic acid, acetic acid, oxalic acid, tartaric acid, citric acid, malic acid or methanesulfonic acid, and the inorganic acid includes hydrochloric acid, sulfuric acid or phosphoric acid.

In an embodiment of the invention, the metal catalyst includes metal compounds of copper, nickel, cobalt, iron or zinc.

In an embodiment of the invention, the metal catalyst includes CuCl₂, Ni(NO₃)₂, Co(NO₃)₂, FeCl₃ or ZnCl₂.

In an embodiment of the invention, based on a total weight of the mixed aqueous solution, a content of the acidic compound is 0.1 wt % to 10 wt %, and a content of the metal catalyst is 0.1 wt % to 5 wt %.

In an embodiment of the invention, a solid-liquid weight ratio of the fragments to the mixed aqueous solution is 1:5 to 1:50.

Based on the above, the present invention provides a recycling method of polyester cotton blended fabrics which mainly uses a hydrothermal reaction catalyzed by high-efficiency circulating acid and metal catalysts, so as to separate and recycle waste polyester-cotton blended fabrics. Through the composite formula of organic acids and metals catalyst combination can cleave cotton more efficiently, thus shortening the process time and lowering the reaction temperature.

### DESCRIPTION OF THE EMBODIMENTS

Hereinafter, embodiments of the present invention will be described in detail. However, these embodiments are exemplary, and the present invention is not limited thereto.

As used herein, a range represented by “one value to another value” is a general representation that avoids listing all the values in the range in the specification. Accordingly, the recitation of a particular numerical range includes any value within that numerical range as well as a smaller numerical range bounded by any values within that numerical range, as if the any value and the smaller numerical range are written in the specification.

The invention provides a recycling method of polyester cotton blended fabrics, which includes the following steps. First, the polyester cotton blend fabric is cuts into fragments. Afterwards, the fragments are placed in a reactor, a mixed aqueous solution of an acidic compound and a metal catalyst is added, a temperature is raised to 110° C. to 160° C., and a reaction is carried out for 1 to 6 hours to cleave the cotton fibers. Next, filter and separate to obtain cotton powders and a polyester fiber.

In the present embodiment, the pressure in the reactor is, for example, 1.5 bars to 12 bars. That is, the reaction is carried out in a high-pressure environment, and a mixed aqueous solution of an acidic compound and a metal catalyst is added under hydrothermal conditions, and is repeatedly applied to the textile fragments in a cyclic and counter-current manner, so as to disintegrate the cotton fibers in the fragments. Afterwards, filtration and separation are performed to obtain cotton powder and polyester fiber, and the catalyst is recovered for recycling.

In this embodiment, the acidic compound is an organic acid or an inorganic acid, the organic acid may include formic acid, acetic acid, oxalic acid, tartaric acid, citric acid, malic acid or methanesulfonic acid, and the inorganic acid may include hydrochloric acid, sulfuric acid or phosphoric acid. However, the invention is not limited thereto. The metal catalyst may include metal compounds of copper, nickel, cobalt, iron or zinc, such as CuCl₂, Ni(NO₃)₂, Co(NO₃)₂, FeCl₃ or ZnCl₂. However, the invention is not limited thereto. Based on the total weight of the mixed aqueous solution, the content of the acidic compound is, for example, 0.1 wt % to 10 wt %, and the content of the metal catalyst is, for example, 0.1 wt % to 5 wt %. The solid-liquid weight ratio of the fragments and the mixed aqueous solution is, for example, 1:5 to 1:50.

Below, the above-mentioned recycling method of the polyester cotton blended fabric of the invention is explained in detail through experimental examples. However, the following experimental examples are not intended to limit the present invention.

### Experimental Example

In order to prove that the recycling method of polyester cotton blended fabric proposed by the invention can more efficiently crack cotton, thereby shortening the process time and lowering the reaction temperature, this experimental example is specially made below.

As shown in Table 1 below, Comparative Example 1 only uses acidic compounds and does not use metal catalysts. Therefore, the reaction temperature is higher, the process time is longer, and the PET recovery rate is also lower. Comparative Example 2 uses only metal catalysts and no acidic compounds. Therefore, the reaction temperature is higher, the process time is longer, and the PET recovery rate is also significantly lower. In comparison, Examples 1 to 8 are based on the recycling method of polyester-cotton blended fabrics of the invention. Through the composite formula of organic acid and metal catalyst, cotton can be more efficiently cracked. Therefore, the process time is shortened and the reaction temperature is lowered, and the PET recovery rate is also higher.

TABLE 1

| | | | | | PET |
|---|---|---|---|---|---|
| | Organic | Metal | Temperature | | recovery |
| | acid | catalyst | (° C.) | Time(Hr) | rate (%) |
| Example 1 | Oxalic | CuCl₂ | 120 | 3 | 98.3 |
| Example 2 | acid | FeC₁₃ | 120 | 3 | 98.8 |
| Example 3 | | Ni(NO₃)₂ | 130 | 2 | 98.6 |
| Example 4 | | ZnCl₂ | 130 | 2 | 98.2 |
| Example 5 | Phosphoric | CuCl₂ | 120 | 3 | 97.5 |
| Example 6 | acid | FeCl₃ | 120 | 3 | 97.3 |
| Example 7 | | Ni(NO₃)₂ | 130 | 2 | 98.1 |
| Example s8 | | ZnCl₂ | 130 | 2 | 98.2 |
| Comparative | Oxalic | — | 140 | 5 | 92.2 |
| Example 1 | acid | | | | |
| Comparative | — | CuCl₂ | 140 | 5 | 85.3 |
| Example 2 | | | | | |

In summary, the invention provides a recycling method of polyester cotton blended fabrics, which mainly separates and recycles waste polyester cotton blended fabrics through a hydrothermal reaction catalyzed by high-efficiency circulating acid and metal catalysts. The compound formula of organic acid and metal catalyst can crack cotton more efficiently, thus shortening the process time and lowering the reaction temperature. In this way, the disadvantages of the conventional technology that the reaction must be carried out at high temperatures, resulting in greater environmental burden or higher production costs can be effectively improved.

What is claimed is:

1. A recycling method of polyester cotton blended fabrics, comprising:
cutting polyester cotton blend fabrics into fragments;
placing the fragments in a reactor, adding a mixed aqueous solution of an acidic compound and a metal catalyst, raising a temperature to 110° C. to 160° C., and carrying out a reaction for 1 to 6 hours to cleave the cotton fibers; and
performing filtration and separation to obtain cotton powders and a polyester fiber.

2. The recycling method of polyester cotton blended fabrics according to claim 1, wherein a pressure within the reactor ranges from 1.5 bars to 12 bars.

3. The recycling method of polyester cotton blended fabrics according to claim 1, wherein the acidic compound is an organic acid or an inorganic acid, the organic acid includes formic acid, acetic acid, oxalic acid, tartaric acid, citric acid, malic acid or methanesulfonic acid, and the inorganic acid includes hydrochloric acid, sulfuric acid or phosphoric acid.

4. The recycling method of polyester cotton blended fabrics according to claim 1, wherein the metal catalyst includes metal compounds of copper, nickel, cobalt, iron or zinc.

5. The recycling method of polyester cotton blended fabrics according to claim 1, wherein the metal catalyst includes CuCl₂, Ni(NO₃)₂, Co(NO₃)₂, FeCl₃ or ZnCl₂.

6. The recycling method of polyester cotton blended fabrics according to claim 1, wherein based on a total weight of the mixed aqueous solution, a content of the acidic compound is 0.1 wt % to 10 wt %, and a content of the metal catalyst is 0.1 wt % to 5 wt %.

7. The recycling method of polyester cotton blended fabrics according to claim 1, wherein a solid-liquid weight ratio of the fragments to the mixed aqueous solution is 1:5 to 1:50.
